(19) United States
(12) Patent Application Publication
(10) Pub. No.: US 2002/0059079 A1
(43) Pub. Date: May 16, 2002

(54) E-service business model

(76) Inventor: Franco R. Negri, Columbia, MD (US)

Correspondence Address: Larson & Associates, P.C., 221 East Church Street, Frederick, MD, 21701-5405, US

(21) Appl. No.: 10/035,601

(22) Filed: Oct. 26, 2001

Related U.S. Application Data
(60) Provisional application No. 60/243,472, filed on Oct. 27, 2000.

(51) Int. Cl. G06F 17/60

(52) U.S. Cl. 705/1

(57) ABSTRACT

A method is described for deriving an e-service management strategy based on business process model. Specifically, given a business process specification that describes the business process of an e-service as well as an infrastructure specification that describes an infrastructure that supports the e-service, an e-service management strategy can be derived aiming at ensuring the service quality of the e-service by incorporating the needs imposed by the business process in the criteria for managing the infrastructure and by monitoring the impact of the infrastructure on the e-service in accordance with the business process.

The instant utility patent application claims the benefit of the filing date of Oct. 27, 2000 of earlier pending provisional application 60/243,472 under 35 U.S.C. 119(e).

### APPLICATION DATA

Five utility patent applications are being filed simultaneously. They are entitled “The eService Business Model”, “Framework for eService Management”, “Behavior Experts in eService Management”, “The Uniform Data Model”, and “Adaptive Feedback Control in eService Management.” They are all assigned to the assignee hereof and the subject matter of each is hereby incorporated into the others.

### BACKGROUND

1. Field of Invention

This invention pertains in general to E-commerce over the Internet. More specifically, the invention provides a new E-Service business model.

2. General Background and Related Art

The expanding use of the World-Wide Web (WWW) for business continues to accelerate and virtual corporations are becoming more commonplace. Many new businesses, born in this Internet Age, do not employ traditional concepts of physical site location (bricks and mortar), on-hand inventories and direct customer contact. Many traditional businesses, who want to survive the Internet revolution are rapidly reorganizing (or re-inventing) themselves into web-centric enterprises. In today's high-speed Business-to-Business (B2B) and Business-to-Customer (B2C) eBusiness environment, a corporation must provide high quality service, scale to accommodate exploding demand and be flexible enough to rapidly respond to market changes.

The growth of eBusiness is being driven by fundamental economic changes. Firms that harness the Internet as the backbone of their business are enjoying tremendous market share gains—mostly at the expense of the unenlightened that remain true to yesterday's business models. Whether it is rapid expansion into new markets, driving down cost structures, or beating competitors to market, there are fundamental advantages to eBusiness that cannot be replicated in the “brick and mortar” world.

This fundamental economic shift, driven by the tremendous opportunity to capture new markets and expand existing market share, is not without great risks. If a customer cannot buy goods and services quickly, cleanly, and confidently from one supplier, a simple search will divulge a host of other companies providing the same goods and services. Competition is always a click away.

eBusinesses are rapidly stretching their enterprises across the globe, connecting new products to new marketplaces and new ways of doing business. These emerging eMarketplaces fuse suppliers, partners and consumers as well as infrastructure and application outsourcers into a powerful but often intangible Virtual Enterprise. The infrastructure supporting the new breed of virtual corporations has become exponentially more complex—and, in ways unforeseen just a short while ago, unmanageable by even the most advanced of today's tools. The dynamic and shifting nature of complex business relationships and dependencies is not only particularly difficult to understand (and, hence manage) but even a partial outage among just a handful of dependencies can be catastrophic to an eBusiness'survival.

Businesses are racing to deploy Internet enabled services in order to gain competitive advantage and realize the many benefits of eBusiness. For an eBusiness, time-to-value is so critical that often these business services are brought on-line without the ability to manage or sustain the service. eBusinesses have been ravaged with catastrophe after catastrophe. Adequate technology, to effectively prevent these catastrophes, does not exist.

eBusiness infrastructures operate around the clock, around the globe, and constantly evolving. If a critical supplier in Asia cannot process an electronic order due to infrastructure problems, the entire supply chain comes to a grinding halt. Who understands the relationships between technology and business processes and between producer and supplier? Are they available 24×7×365? How long will it take to find the right person and rectify the problem? The promise of B2B, B2C and eCommerce in general will not be fully realized until technology is viewed in light of business process to solve these problems.

Web-enabled eBusiness processes effectively distill all computing resources down to a single customer-visible service (or eService). For example, a user interacts with a web site to make an on-line purchase. All of the back-end hardware and software components supporting this service are hidden, so the user's perception of the entire organization is based on this single point of interaction. How can organizations mitigate these risks and gain the benefits of well-managed eServices?

Never before has an organization been so dependent on a single point of service delivery—the eService. An organization's reputation and brand depend on the quality of eService delivery because, to the outside world, the eService is the organization. If service delivery is unreliable, the organization is perceived as unreliable. If the eService is slow or unresponsive, the company is perceived as being slow or unresponsive. If the Service is down, the organization might as well be out of business.

Further complicating matters, more and more corporations are outsourcing all or part of their web-based business portals. While reducing capital and personnel costs and increasing scalability and flexibility, this makes Application Service Providers (ASPs), Internet Service Providers (ISPs) and Managed Service Providers (MSPs) the custodians of a corporation's business. These “xSPs” face similar challenges—delivering quality service in a rapid, cost efficient manner with the added complication of doing so across a broad array of clients. Their ability to meet Service Level Agreements (SLAs) is crucial to the eBusiness developing a respected, high quality electronic brand—the equivalent of prime storefront property in a traditional brick and mortar business.

The Internet enables companies to outsource those areas in which the company does not specialize. This collaboration strategy creates a loss of control over infrastructure and business processes between companies comprising the complete value chain. Partners, including suppliers and service providers must work in concert to provide a high quality service. But how does a company control infrastructure which it doesn't own and processes that transcend its' organizational boundaries? Even infrastructure outsourcers don't have mature tools or the capability to manage across organizational boundaries.

The underlying problem is not lack of resources, but the misguided attempt to apply yesterday's management technology to today's eService problem. As noted by Forrester Research, “Most companies use ‘systems’ management tools to solve pressing operational problems. None of these tools can directly map a system or service failure to business impact.” To compensate, they rely on slow, manual deployment by expensive and hard-to-find technical personnel to diagnose the impact of infrastructure failures on service delivery (or, conversely, to explain service failures in terms of events in the underlying infrastructure). The result is very long time-to-value and an unresponsive support infrastructure. In an extremely competitive marketplace, the resulting service degradation and excessive costs can be fatal.

### BRIEF DESCRIPTION OF THE DRAWINGS

The present invention is further described in the detailed description which follows, by reference to the noted drawings by way of non-limiting exemplary embodiments, in which like reference numerals represent similar parts throughout the several views of the drawings, and wherein:

FIG. 1 shows an eService delivery model;

FIG. 2 shows the gap between traditional infrastructure management and external service management;

FIG. 3 shows an eService model; and

FIG. 4 shows an example of a (product purchasing) business process.

### DETAILED DESCRIPTION

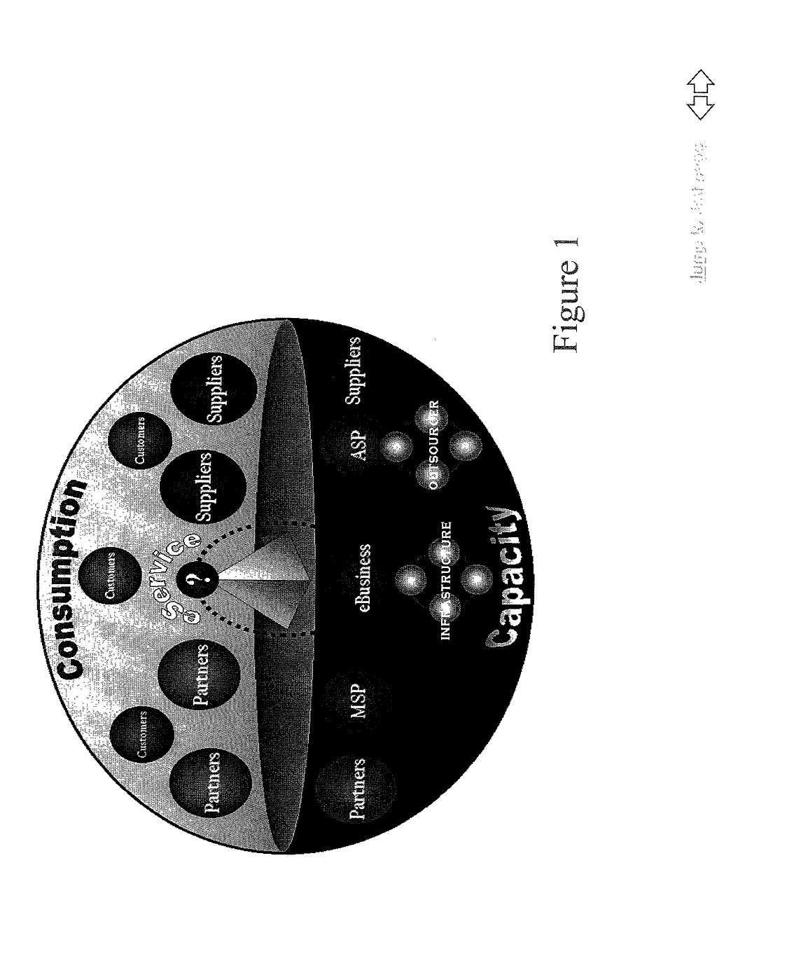

Even if a company can internally host its infrastructure (or, alternatively, outsource everything to a single service provider), leading edge business models require managing the complexity of a distributed supply chain. Increased specialization means that a virtual organization, composed of the eBusiness and its partners, suppliers, and customers, must work seamlessly to ensure eService delivery. These dependencies make it impossible for eBusinesses, managed in isolation, to guarantee service delivery levels. FIG. 1 illustrates a distributed eService Delivery Model.

In this view, the eService is represented as a pyramid, because it distills all of the required components (the capacity resources), including those provided by external service providers and partners, down to a single point of delivery that is accessed by the customers and partners consuming the service. All of these resources must be managed with a focus on ensuring the quality of eService delivery.

Managing eBusiness Delivery

A new world of interconnected business is rapidly emerging from the chaos of the Internet. In this world, eBusinesses and highly distributed virtual enterprises are contending for dominance throughout the millennium. These eBusinesses are totally service oriented. Shedding their brick and mortar superstructure, the retailers, manufacturers, and service organizations of the Internet Age are increasingly dependent on the effective management of their own distributed infrastructure to provide a constantly available window of service opportunity to customers, partners, and supply chain vendors across the globe.

The emerging eMarketplaces are fusing suppliers, partners, consumers as well as infrastructure and application outsourcers into a powerful but often intangible Virtual Enterprise. It is essential to provide the ability to discover and model the dependencies of this virtual supply chain and then using distributed intelligence modules, which allow for the commoditization of technology, to provide the ability to understand the intrinsic relationships and proactively diagnose problems that affect eService delivery.

Existing solutions to monitor Internet quality of service focus on managing individual components (PCs, servers, applications, etc.)—an approach stemming from pre-Internet architectures and not suitable for the scope or scale of eBusiness. The Internet distills all computing resources down to a single customer-visible “service” (also known as an eService). For example, a user interacts with a web site to make an on-line purchase. All of the back-end hardware and software components supporting this service are hidden, so the user's perception of the entire organization is based on this single point of interaction. If the service is inadequate, thousands of competitors are just a click away. The catastrophic consequences of inadequately managed eServices include loss of significant revenue and market capitalization.

Existing solutions, therefore, create a fundamental disconnect, or misalignment, between what IT can deliver and the needs of eBusiness. While the demands are higher, the risks greater and the environments more complex, management tools have not evolved rapidly enough. Bridging this gap requires a new breed of management solutions that provides automated analysis and advanced management services by understanding the relationship between infrastructure and eService delivery.

The eBusiness Service Management challenge is to facilitate the lean and sometimes mean approach necessary to support the eBusiness model. In short, the solution must:

Ensure high quality of service

Scale rapidly to enable growth

Deliver rapid time-to-value

Manage across a distributed virtual enterprise

Unfortunately, legacy management tools fall short of each objective. Built for earlier generations of computing, legacy management tools focus on systems, not services. Generally classified under the headings Systems Management or Enterprise Systems Management, they monitor low-level hardware and software components such as systems, network elements, databases and applications without a methodology for understanding the complex interactions and external influences that impact service delivery. As a result, their burdensome approach requires a highly trained IT staff to analyze the flood of low-level data and deduce the impact on service delivery. “Is high memory utilization on server XYZ a serious problem? Is it related to the high rate of transmitted packet loss from system ABC? Are they even working on the same service? If so, will either impact service delivery?”

It comes as no surprise to experienced Service Provider and Line of Business (LOB) managers that measuring component conflicts and failures often has little or no relationship to the quality of service. In fact, the implementation time and costs are so high, and the value received so low, that the Hurwitz Group says the percentage of successful Enterprise Systems Management projects “closely approximates zero.”

A common response to the internal focus of systems and network management products is to add a Service Level Management (SLM) tool that measures service delivery. For example, a popular class of SLM solution records a series of web transactions for periodic playback and measurement (e.g. I want to know the load time of my home page experienced by users in New York, Chicago, Los Angeles, London and Tokyo). These “synthetic transactions” are measured and compared to norms for reporting purposes. The weakness of this external approach is that it may indicate a service problem, but cannot identify its source. Additionally, the information has no business context. “Is this response time having an impact on my partner? Is my supplier's transaction affecting my customer?”

It might seem that the combination of internally based legacy tools with externally based SLM tools creates a complete solution. After all, one manages the capacity side (components) and the other manages the consumption side (user experience) illustrated in FIG. 1. Unfortunately, this strategy doesn't work. Because neither was designed to understand the relationship between a component and service delivery or business process, they are fundamentally incompatible. At best, one will identify that there is a problem which may be in the infrastructure, the other will provide a list of possible causes for operations to pursue—resulting in delayed response and deteriorating service levels. “Performance is slow from Chicago—is it the Internet or something inside? Performance is slow from LA too—it's probably an internal problem, but which one?”

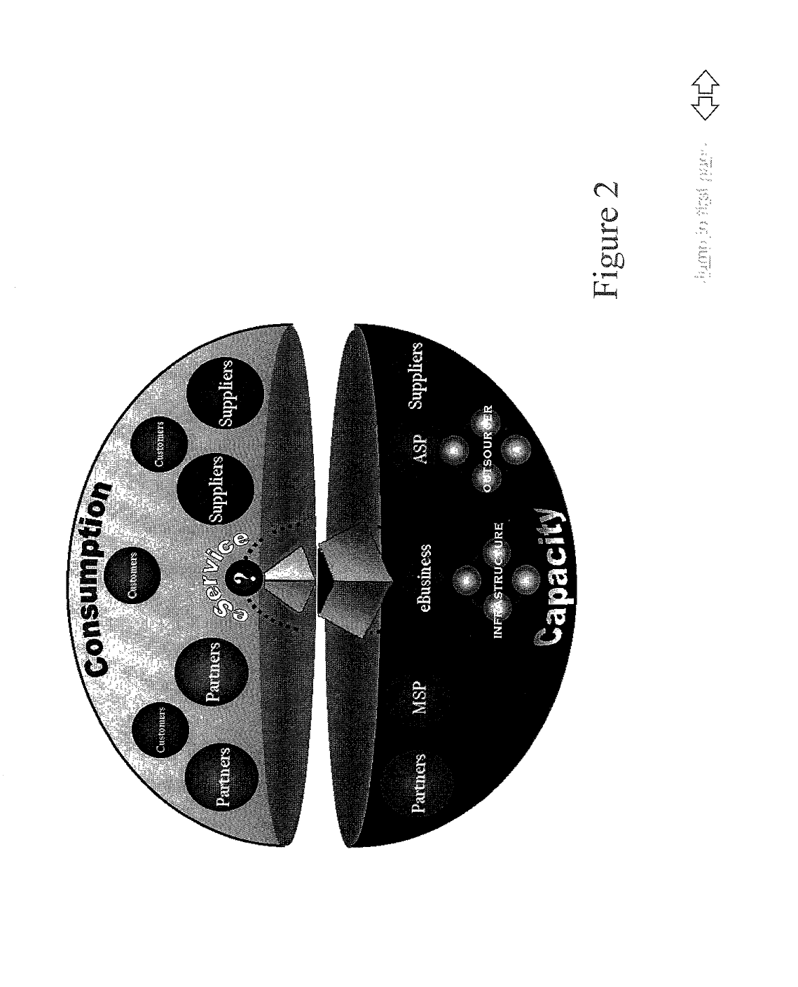

FIG. 2 illustrates this fundamental disconnect. Understanding, predicting and controlling the service from both a capacity and customer or partner (consumption) perspective requires a new approach, eService Management (eSM).

eService Management

eSM manages the service resources with an exclusive focus on ensuring peak performance of eBusiness services. Unlike conventional component-level analysis and management, which simply attempts to understand the whole through the study of its parts, eService Management starts at the top—the point of contact between the client and the business or between collaborating partners. All monitoring, analysis and control is done in context of the service—how will the observed behavior impact service delivery? eSM provides only meaningful management information (instead of raw event data) that conveys the state of service delivery and identifies impending threats within the eService infrastructure and business processes.eService Management relies on three critical principles:

Analyzing the service delivery process requires understanding the relationships in the eBusiness infrastructure

Scalable management requires distributing intelligence throughout the virtual enterprise—forwarding only meaningful information to other managed elements and centralized service management

Rapid, flexible deployment requires capturing and replicating service management knowledge in plug-and-play modules that are independent of the specific eBusiness architecture

eService management fulfills these principles using a combination of eService modeling and a revolutionary, distributed intelligence technology known as “Business eXperts” (BeXs)™. The result is a scalable system that enables eBusinesses to deliver on quality of service commitments with confidence.

Modeling eService Business Architectures

A web-centric business is more than a collection of application components such as databases, web servers, inventory systems, customer order entry systems, and so forth. The business process involves the flow of data and control through a complex arrangement of these components coupled to the web server and client interface. eService management must understand this flow of data, component dependencies and management perspectives, both within the internal infrastructure and across the partners in the virtual enterprise, before an effective model of the entire process is possible. A service-centric approach is fundamental that focuses on the management of technology in the content of actual service delivery. This approach eliminates the inefficiencies, risks, and errors caused by conventional technology-centric solutions.

Thus, an intrinsic as well as critical part of eService management is modeling the eService delivery process itself. An eService model

Defines the principal components in a service. These include the software services and related physical elements that combine to deliver the service, whether internal or provided by service providers, partners, or suppliers.

Collects and organizes the components in a multi-dimensional taxonomy. Components are modeled by service delivery function and aligned with organizational objectives. Process and responsibilities may be defined by function, geography, organization, product, business process, management responsibility or service perspectives.

Establishes implicit and explicit relationships. More than simple hierarchical dependencies, the relationship graph defines the actual topology of the model. Components can depend on each other, of course, but they can also share common resources, exchange data with each other, collect common statistics, and work together in complex flows of control.

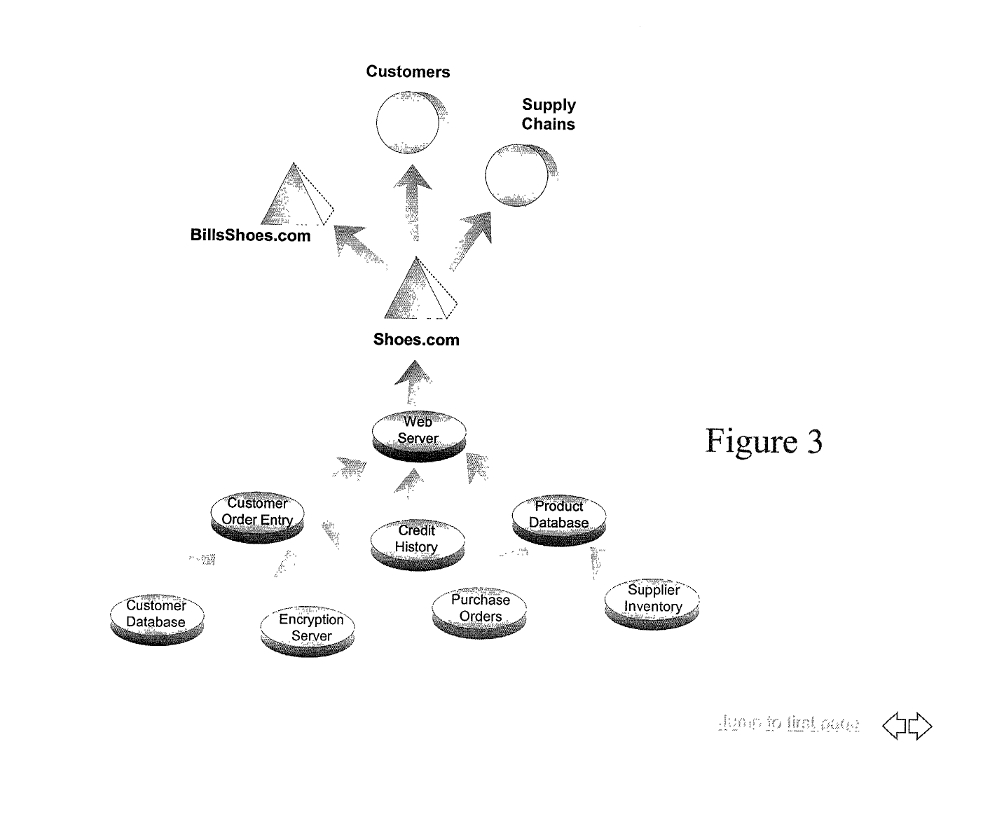

FIG. 3 illustrates how the eService delivery process is organized into a dependency graph of business applications with their operational relationships. Thus, as an example, the Customer Order Entry system depends on an implicit access to the Customer Database, the Encryption Server (for secure transactions) and the Active Customer History file. eSM recognizes, understands and manages these dependencies whether they are within a physical organization or across a virtual enterprise (intercompany transactions which cross organizational boundaries).

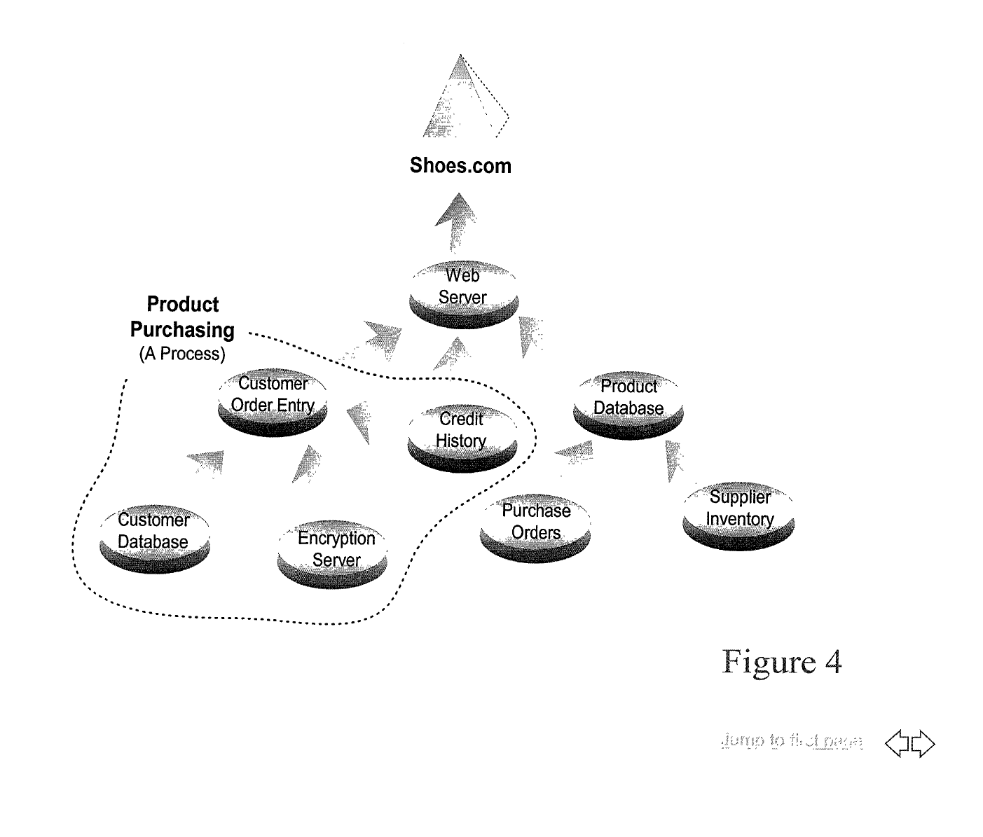

The eService modeling approach is flexible enough to accommodate any sort of classification. For example, components can be further aggregated to provide insight into the behavior of specific business processes—e.g. in FIG. 4 the infrastructure components that are related to the business process “Product Purchasing” are aggregated into a single manageable entity. This facilitates eSM's policy-based management and reporting. Individuals or groups are assigned duties and responsibilities (roles) for management of collections of resources during specified time periods (the right information to the right person at the right time). For example, three shifts of operators may be able to monitor the Product Purchasing business process, but the database administrator must be paged if any DB is performing poorly or showing signs of impending failure.

Bringing in the Experts

eService modeling is done with one purpose in mind—to facilitate understanding and analysis of eService behavior and delivery. This leads to the fourth critical property of an eService model—

eService Management constructs a model of the components' combined operations.

In the eService approach this involves deploying intelligent “Business eXperts” (BeXs) on the components within the dependency chart. The BeXs combine rules of behavior with statistical analysis techniques to observe, learn, and, ultimately, optimize and control the entire functional model.

BeXs have three critical properties which differentiate them from simple management agents offered in many of today's system management tools: (1) a BeX is developed independent of a specific model; (2) upon implementation, a BeX will utilize the relationships within the eService Model to analyze the impact of related components; and (3) a BeX has a very comprehensive yet efficient local processing engine. The result is that BeXs can be deployed as “plug and play” components that leverage the relationships in the eService model to understand and analyze the effect of a component on eService delivery.

This modular BeX approach enables an expert in the management of a particular component to create a BeX that can be sold and implemented in any environment utilizing that component (e.g. a WebLogic BeX can be deployed at any site built upon BEA's WebLogic application server). In essence, a BeX is a recorded “best practice” for a component of a service that can be implemented without on-site development. Industry leading experts, including consultants, integrators and application vendors, are currently developing BeXs for the “fabric of the Internef”, including leading web servers, application servers, databases, load balancers, firewalls, etc. This ability to capture and replicate the knowledge of the best and the brightest serves two purposes: first, to create a market for management expertise that extends beyond the expert's ability to directly implement and second, to speed installation and growth of the infrastructure.

The deployment of BeX “building blocks” throughout the managed infrastructure has another important benefit—scalability. Not only can organizations replicate service delivery best practices at will, but their resources may also be more efficiently focused on eService delivery. By analyzing each component locally, only a relatively small number of meaningful events and supporting data are forwarded to the eService Management server. This is in contrast with offerings that simply take component measurements and forward raw data to a central location, which creates a volume of events that overwhelms meaningful attempts at automated analysis and depends on operator analysis. With an estimated 50% of new IT jobs going unfilled (U.S. Department of Labor), an intelligent management system that reduces the burden on the operations staff is a pre-requisite for growth.

Most importantly, by combining analytical and data modeling technology with the relationships defined in the model, BeXs analyze not just intra-component behavior (e.g. how an application interacts with the operating system, hardware, etc.) but also external or inter-component behavior (e.g. how it interacts with other applications). Thus it is possible to view, understand and manage the entire eService model—right up to and including the point of service delivery. “How does a problem in the customer database affect the order entry system? How will that affect shoes.com's ability to sell shoes?” The gap between external service measurement and infrastructure management is gone. With such an eService management solution, an eService infrastructure can be managed based on eService delivery and, ultimately, based on the organization's business objectives.

Controlling eBusiness

eBusiness has created a fundamental shift in the way organizations are evaluated. Customers, suppliers, partners, and employees are focused now, more than ever, on single points of service delivery. The exponential growth of Internet-based business processes and service offerings has outpaced the capacity of current management technology. Failed attempts to manage critical business resources using out-dated and incomplete approaches can no longer be tolerated. Complex service delivery models such as distributed supply chains, B2B marketplaces, etc. require solutions that understand the impact of failing components on service delivery, before the service is affected. A new approach, one enabling organizations to assure high service quality and achieve the otherwise expected economies of scale, is now an imperative.

The present invention provides such a solution by understanding the principles of eService Management and developing a service delivery model with intelligent controls, bridging the gap between external web monitoring and infrastructure management. Business Experts focus on analyzing and understanding the behavior of components, processes, and services to assure the customer experience at the point of service delivery by providing a complete understanding of these distributed and interdependent service resources to allow a user to control eBusiness.

What is claimed is:

1. A method for deriving an e-service management strategy, said method comprising:
obtaining a business process specification that describes the business process of said e-service;
obtaining an infrastructure specification that describes an infrastructure that supports said e-service; and
deriving an e-service management strategy based on said business process specification and said infrastructure specification, said e-service management strategy aiming at ensuring the service quality of said e-service by incorporating the needs imposed by the business process in the criteria for managing said infrastructure and by monitoring the impact of said infrastructure on the e-service in accordance with the business process.

2. A method for managing an e-service, said method comprising:
observing the infrastructure behavior of an infrastructure that supports said e-service;
observing the stress behavior, imposed from outside of said infrastructure, on said e-service;
analyzing said infrastructure behavior in relation to said stress behavior with the perspective of the business process model of said e-service; and
optimizing said infrastructure behavior based on the analysis from said analyzing to optimize the service of said e-service by ensuring the business process flow of said e-service.

3. The method according to claim 2, wherein said infrastructure behavior includes various events observed from said infrastructure that form the knowledge about said infrastructure at different time instances.

4. The method according to claim 2, wherein said infrastructure comprises at least one of e-service, services, applications, systems, components, and resources.
